(19) United States
(12) Patent Application Publication
(10) Pub. No.: US 2025/0326475 A1
(43) Pub. Date: Oct. 23, 2025

(54) MANIPULATOR DEVICE WITH DIVERLESS DOCKING IN A PIPELINE AND METHODS FOR POSITIONING AND CONTROLLING THE MANIPULATOR DEVICE

(71) Applicant: PETRÓLEO BRASILEIRO S.A. - PETROBRAS, Rio de Janeiro (BR)

(72) Inventors: DANIEL DIAS GOMES XAVIER, Macaé (BR); ANDRE LUIZ BEVILAQUA SANTANA, Macaé (BR)

(73) Assignee: PETRÓLEO BRASILEIRO S.A. - PETROBRAS, Rio de Janeiro, RJ (BR)

(21) Appl. No.: 19/182,732

(22) Filed: Apr. 18, 2025

(30) Foreign Application Priority Data
Apr. 19, 2024 (BR) 1020240084411

(51) Int. Cl. B63G 8/00; B25J 9/00; F16M 13/02; H04N 23/56; H04N 23/57; H04N 23/66; H04N 23/695

(52) U.S. Cl. CPC B63G 8/001; B25J 9/0009; H04N 23/56; H04N 23/57; H04N 23/66; H04N 23/695; B63G 2008/005; F16M 13/022

(57) ABSTRACT

The present invention is related to subsea technologies, and describes a manipulator device with diverless docking in a pipeline that has the purpose of performing maintenance and inspection operations on pipelines and equipment in shallow water depths (WD), especially in the Tidal Variation Zone (TVZ) where hydrodynamic forces are high. The device is formed by: a main structure (1), a handle (2), at least two manipulators (3), at least two grippers (4), an umbilical (5), a bend stiffener (6), a hydraulic actuator (7), at least one pole (8), a camera and pan & tilt lighting assembly (9), and at least two magnetic hangers (10). The device has the following functions: docking at the work site (a pipeline or other structure where the grippers can be secured to, when closed); moving the manipulator according to the service; and viewing, through the camera and pan & tilt lighting assembly (9), whether the operation is being performed correctly. The method for positioning and controlling the device is carried out by positioning the device at the work site by an ROV, or by a human diver, and after docking at the work site, the device can be controlled by means of an umbilical that connects the same to an ROV or be remotely controlled by the platform by means of an umbilical.

### FIELD OF THE INVENTION

The present invention is related to subsea technologies, more specifically to the subsea maintenance and inspection technologies in pipelines and risers. More specifically, the present invention is further related to tools for subsea maintenance and inspection in pipelines and risers, with the aim of ensuring greater safety and productivity in the operation.

### BACKGROUND OF THE INVENTION

Currently, there are several subsea maintenance and inspection operations carried out in shallow waters, operations such as: cargo transfer in pull-in and pull-out operations; general cargo transfer operations with shallow diving, installation of rigid spool cases in pull-in operations; operations in the pontoon of semi-submersible platforms; operations inside the turret in FPSO platforms with single point anchoring; replacement of cases in a mid-water connector in the riser section.

These operations are carried out in shallow water depths (WD), especially in the Tidal Variation Zone (TVZ) where hydrodynamic forces are high, and two types of resources are used for the operation: the human diver and the Remotely Operated Vehicle (ROV).

Initially, the operations were carried out only by human divers, which is a high-risk operation for the diver, considered as Man Hour Exposed to Risk (MHER) and which has a history of accidents, including fatal ones, in addition to being an operation with low efficiency, since there are restrictive meteoceanographic conditions, due to the influence of the swell and stream in this region, and there is a limit on the time in which the diver can remain at the bottom, according to NORMAN 15 (Navy Regulatory Standard that Deals with Diving in Brazil).

In this way, due to the risks associated with human diving operations, an initiative was introduced to eliminate this type of operation, replacing the human diving operations with ROV operations on the platforms that were designed for diving interventions that, in addition to having difficult access for the ROV, did not have docking and parking points for the ROV.

However, when performing operations with the ROV, it was observed that the ROV does not operate well, because, in operations in shallow water depths (WD), especially in the TVZ where hydrodynamic forces are high, the ROV has difficulty maintaining its position and remaining stable enough to be able to perform the operation, in addition to putting the equipment at risk, because, when trying to maintain its position in the stream conditions of the Tidal Variation Zone (TVZ), the thrusters require a lot of power, which increases the oil temperature and puts the integrity of the ROV systems at risk.

An alternative to the ROV to maintain its position would be to dock with one of its arms while performing the service with the other arm; however, the dynamics of the relative movement between the platform and the ROV make it impossible to dock the ROV to its structure, as it subjects the ROV arm to an excessive load, with the risk of breaking the manipulator, which would limit the operation in very restrictive sea conditions that only occur on a few days of the year, generally in the summer at the beginning of the year.

In this context, the manipulator device with diverless docking in a pipeline of the present invention makes it possible to eliminate some shallow diving operations without presenting the problems of operating with an ROV, as the present invention discloses a new type of alternative resource to both, in which the manipulators that perform the service, instead of being integral with the ROV, will be integral with the structure in which the service will be performed.

In this way, since it is attached, this solution will not be subject to the difficulties of operating in the TVZ, since it will not need to activate thrusters to compensate for the resultant hydrodynamic forces.

This device can be used in subsea maintenance and inspection operations on pipelines and equipment, mainly in activities that until then were only carried out with shallow diving, as long as there is a preferably cylindrical structure nearby, so that the manipulator device can be attached to the same.

### STATE OF THE ART

In the state of the art, documents can be found that disclose technologies related to the technology of the proposed invention.

Document of the state of the art CN 115218062 A discloses a special robot for underwater pipeline maintenance with high adsorption stability. The special underwater pipeline maintenance robot comprises a housing and an adsorption drive unit, the first helices are arranged in mounting grooves formed at the four corners of the upper surface of the housing, the second helices are arranged in attaching grooves longitudinally and symmetrically formed at the rear end of the hull, a six-axis mechanical arm is arranged in a mounting groove formed in the middle of the upper surface of the hull, an underwater camera is arranged at the left end of the upper surface of the six-axis mechanical arm, and an LED lamp is arranged at the left end of the housing; the adsorption drive unit is arranged at the lower end of the casing; wherein the robot further comprises a PLC, the input end of the PLC is electrically connected to an external power source, the situation wherein the special robot for underwater pipeline maintenance is separated from a maintenance pipeline due to water flow is avoided, and the adsorption stability of the special robot for underwater pipeline maintenance during operation is greatly improved.

Document of the state of the art CN 116812116 A relates to a robot for underwater structure cleaning and detection operation comprising a floating carrier, a propulsion mechanism, a thrust mechanism and a cleaning device. The floating carrier comprises a floating body and a main frame body, and the floating body provides buoyancy for the main frame body; the propulsion mechanism is arranged on the main frame body; the thrust mechanism comprises a thrust frame and a thrust piece, the thrust frame is hinged to the main frame body, the thrust piece is rotatably connected to the thrust frame, the propulsion mechanism pushes the floating support underwater to allow the thrust piece to thrust against the surface of the oceanic structure, and the robot can adapt to the surfaces of the oceanic structures with different curvatures. The cleaning device comprises a cleaning mechanism and an attachment device, the attachment device is attached to the main frame body, and the cleaning mechanism is telescopically arranged on the attachment device, so that the distance between the cleaning mechanism and the oceanic structure and the cleaning range of the oceanic structure can be adjusted, and the cleaning efficiency and the operating capability level of the robot can be improved.

Document of the state of the art US 2018079086 A1 provides systems and methods for attaching a remotely operated vehicle (ROV) to a subsea structure during the cleaning, maintenance or inspection of the surface of the structure. In one or more embodiments, an attachment mechanism includes a pair of gripping hooks that are raised and lowered when actuated by a motorized drive. In one or more embodiments, an attachment mechanism includes a rigid support having a mechanical stop and connected to a swing arm, the swing arm configured to rotate inwardly but not outwardly past the mechanical stop. In one or more embodiments, an attachment mechanism includes a plurality of segments connected in series, each connected to a plurality of points of articulation. A pair of wires passes through the plurality of connected segments and connects to a pair of pulleys that extend or retract the wires, thereby rotating the plurality of connected segments.

Document of the state of the art CN 109229310 A discloses an underwater robot for cleaning and detecting external circular pipes, which comprises a chassis, a helix propulsion system, a mechanism for adjusting the center of gravity, a cleaning system, a manipulator, a light communication system, and an operation detection tool. The chassis is located below the robot and is used to provide a stable operation platform for supporting and crawling the robot. The helix propulsion system is attached to the top of the chassis to drive the suspension of the robot. The mechanism for adjusting the center of gravity is located below the chassis to adjust the position of the center of gravity of the robot. The cleaning system is attached under the front part of the chassis and is used for underwater cleaning. The manipulator is attached to the front part of the robot chassis and is used to grasp the operation detection tool. The light communication system is used to provide lighting, camera, and external communication functions. At the same time, the invention has the function of cleaning and detection, has flexible operation, small environmental influence, large operating time window and moderate operating cost, and can provide a stable detection platform for the detection of offshore and underwater facilities, and improves the detection accuracy.

In this way, it is important to emphasize that, unlike the presented documents of the state of the art, the manipulator device of the present invention does not have thrusters, being a system of robotic manipulators that reach the work site with the help of an ROV, or even a diver, which attaches the same to the structure of the work site (platform, pipeline, subsea equipment, etc.), that is, the device of the present invention needs a means of transportation to be positioned at the work site. This makes the manipulator device of the present invention not a subsea vehicle, but rather a tool that expands the capabilities of the traditional ROV, a type of “extension” of the ROV, which expands its operations portfolio, unlike the documents mentioned above. This feature also allows the invention to have a more compact design, which guarantees access to more restricted or confined locations, which the ROVs available on the market cannot access in a conventional way.

In addition, the manipulator device of the present invention presents a system of articulated grippers that close the grippers that are secured to the pipeline, performing a tightening that guarantees the attachment and avoids the need to maintain the position at the work site by activating the thrusters. The documents of the state of the art CN 115218062 A, CN 116812116 A and CN 109229310 A, despite indicating that the device rests on the pipeline, do not present this gripper system, with the thrusters being responsible for keeping the device supported on the pipeline, that is, in this case the device “lands” on the pipeline. The document of the state of the art US 2018079086 A1, in turn, presents a mechanism for attachment the vehicle to the structure. However, in this document, the attachment system uses hooks with a closing mechanism consisting of a worm gear that rotates a shaft that simultaneously drives two pairs of bevel gears that transmit the movement to the hooks, unlike the proposed invention, which uses grippers with a closing mechanism consisting of a rack that simultaneously drives the pinions responsible for moving the grippers, and in this concept, the mechanism assembly has the advantage of being simpler, more compact and lighter than that of document US 2018079086 A1.

### BRIEF DESCRIPTION OF THE INVENTION

The manipulator device with diverless docking in a pipeline is formed by: a main structure (1), a handle (2), at least two manipulators (3), at least two grippers (4), an umbilical (5), a bend stiffener (6), a hydraulic actuator (7), at least one post (8), a camera and pan & tilt lighting assembly (9), and at least two magnetic hangers (10). The device has the following functions: docking at the work site (a pipeline or other structure in which the grippers, when closed, can be secured to the platform structure); moving the manipulator according to the service; and viewing, through the camera and pan & tilt lighting assembly (9), whether the operation is being performed correctly.

The method of positioning and controlling the device is carried out by positioning the device at the work site by an ROV, and wherein, after docking at the work site, the device can be controlled by means of an umbilical that connects the same to an ROV and is controlled directly remotely by the platform by means of an umbilical, or it is controlled remotely by the RSV vessel (ROV Support Vessel) by means of an umbilical.

### BRIEF DESCRIPTION OF THE FIGURES

In order to obtain a complete and total visualization of the object of this invention, the figures to which references are made are presented, as follows.

FIG. 1 shows a front perspective view of the manipulator device with diverless docking in a pipeline.

FIG. 2 shows a rear perspective view of the manipulator device with diverless docking in a pipeline.

FIG. 3 shows the mechanism for opening and closing the gripper of the device.

FIG. 4 shows a front perspective view of the manipulator device with diverless docking in a pipeline with another type of tip on the gripper.

FIG. 5 shows an ROV positioning the device of the present invention in an operation.

FIG. 6 shows the device in operation.

FIG. 7 shows the device in operation with another type of tip on the gripper.

FIG. 8 shows the device of the present invention in an operation, being remotely operated by an ROV by means of an umbilical.

FIG. 9 shows the device of the present invention in operation, being operated remotely directly from the platform.

### DETAILED DESCRIPTION OF THE INVENTION

The present invention describes a manipulator device with diverless docking in a pipeline, which is intended to perform maintenance and inspection operations on pipelines and equipment in shallow water depths (WD), especially in the Tidal Variation Zone (TVZ) where hydrodynamic forces are high, thus, avoiding the risks associated with using a human diver to perform said operations, and also avoiding the problems of performing the operations with an ROV, as the invention discloses a new type of alternative resource to both, in which the manipulators performing the service, instead of being integral with the ROV, will be integral with the structure (equipment, platform, etc.) in which the service is performed.

To accomplish such a feat, the manipulator device with diverless docking in a pipeline comprises a main structure (1), a handle (2), at least two manipulators (3), at least two grippers (4), an umbilical (5), a bend stiffener (6), a hydraulic actuator (7), at least one pole (8), a camera and pan & tilt lighting assembly (9), and at least two magnetic hangers (10).

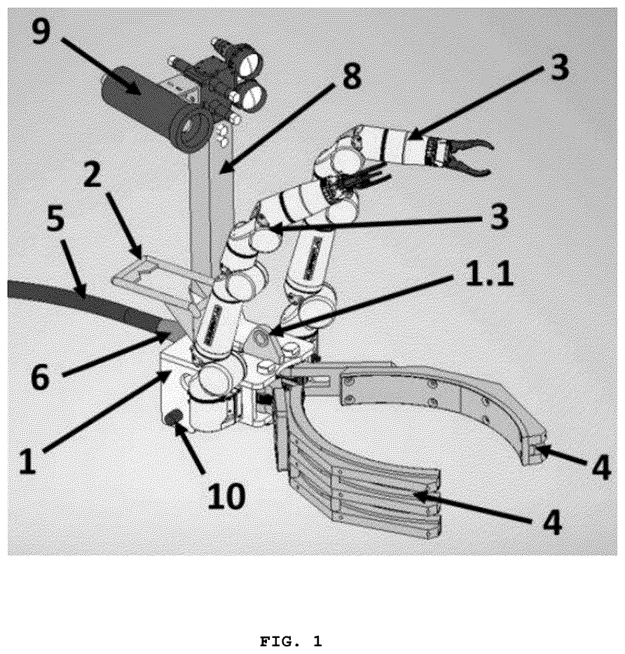

Based on FIG. 1, it is on the main structure (1) that all the structural components that make up the device of the present invention are mounted. In addition, the main structure (1) is made from light polymeric materials, or duralumin, in order to reduce the total weight of the structure and facilitate the transportation of the device to the work site, where the device will be anchored.

Based on FIG. 1, it is on the main structure (1) that an eyelet (1.1) is mounted, and in which said eyelet (1.1) is the structural element attached to the front part of the main structure (1) through which the device of the present invention is hoisted by a winch, or any other hoisting mechanism used.

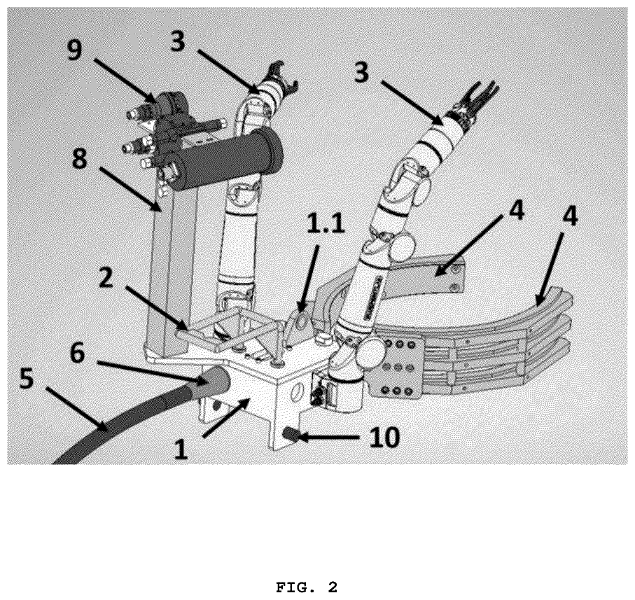

Based on FIGS. 1 and 2, the handle (2) is mounted on the rear part of the main structure (1), and has a handle that serves as a contact surface on which the ROV grips the device to position the same in the work site.

At least two manipulators (3) are mounted on the sides of the main structure (1), which are the arms responsible for performing the service, and in which the at least two manipulators (3) are positioned on opposite sides of the main structure (1) in a symmetrical manner.

The respective at least two manipulators (3) are adaptable, that is, it is possible to alter and configure different tools depending on the operation to be performed with the same, presenting at least seven functions. The respective at least two manipulators (3) further have force adjustment, allowing the application of the necessary force depending on the performed operation. In addition, the at least two manipulators (3) have at least 2 degrees of freedom in at least two articulations, enabling the movement of the at least two manipulators (3), and are attached to the sides of the main structure (1) by means of screws.

The at least two magnetic hangers (10) are also mounted on the sides, which are a magnetic handle that functions as a support for tools and/or materials that will be used to perform the operations, and in which at least two magnetic hangers (10) are positioned on opposite sides of the main structure (1) in a symmetrical manner.

In this way, when necessary, one of the at least two manipulators (3) takes the tool or material that will be used in the operation from one of the at least two magnetic hangers (10), so that the manipulator (3) will take the tool or material from the magnetic hanger (10) corresponding to its side of the main structure (1).

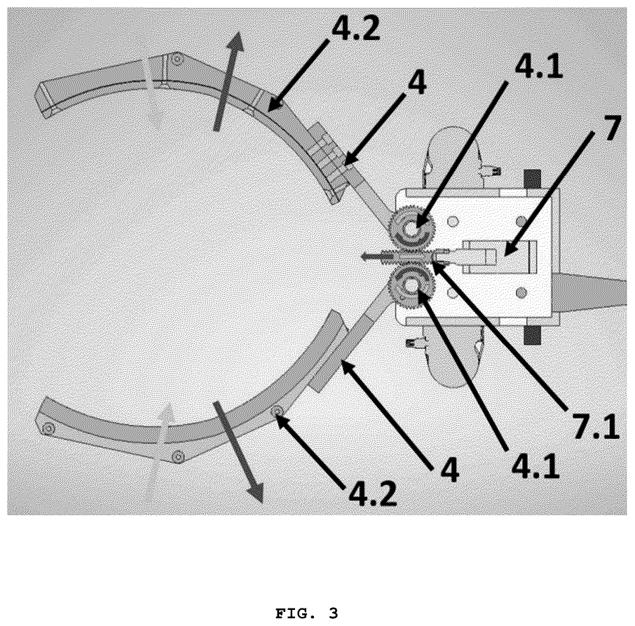

Based on FIG. 3, it is possible to observe a bottom view of the main structure (1), in which it is also possible to observe the assembly in the lower central part of the main structure (1) with the hydraulic actuator (7).

Further based on FIG. 3, the assembly of the at least two grippers (4) of the device of the present invention is shown. The at least two grippers (4) are formed by a flat surface with a gear (4.1) at its end, in which in the middle of the gears (4.1) of the at least two grippers (4) there is a hole, through which a pin passes. Said pin that passes through the hole of the gears (4.1) of the at least two grippers (4) is responsible for attaching the at least two grippers (4) to the main structure (1), forming an articulated mechanism.

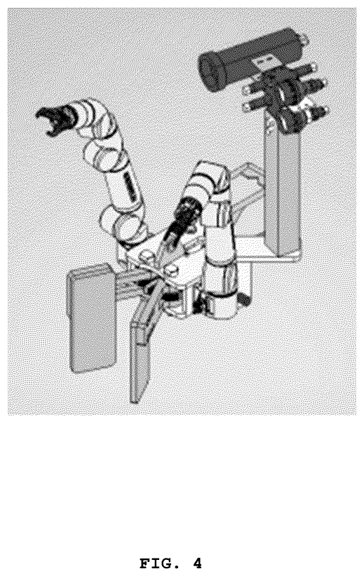

The flat surface of the at least two grippers (4) have holes in order to attach the at least two tips (4.2) by means of screws. The at least two tips (4.2) can be shifted according to the geometry and dimensions of the structure in which the device of the present invention will dock, as shown in FIG. 4, which presents the at least two rectangular tips (4.2).

Said at least two tips (4.2) can be made from a magnetic material, in order to facilitate the attachment to the structure in which the device of the present invention will dock, and further allowing the expansion of varieties of geometry in which the device of the present invention can be attached.

Said hydraulic actuator (7), as shown in FIG. 3, has at one of its ends a rack (7.1), in which said rack (7.1) is in contact with the gears (4.1) of the at least two grippers (4).

In this way, when the hydraulic actuator (7) advances or retreats the rack (7.1) mounted on its tip, this rack (7.1) turns the gears (4.1) of the at least two grippers (4), opening or closing the grippers (4).

When the hydraulic actuator (7) advances the rack (7.1), the gears (4.1) enter into a clockwise rotational movement, thus opening the at least two grippers (4). Conversely, when the hydraulic actuator (7) retreats the rack (7.1), the gears (4.1) enter into a counterclockwise rotational movement, thus closing the at least two grippers (4). These rotational movements can be seen from the representative arrows in FIG. 3.

Further, on the main structure (1), the umbilical (5) is attached, an element responsible for transmitting all commands, electrical energy and hydraulic pressure to the platform or the ROV that will control the device, with the bend stiffener (6) being mounted at the attachment point of the umbilical (5) on the main structure (1), which is responsible for the gradual transition of stiffness to prevent the umbilical cable (5) from breaking at this attachment point because of its movement due to hydrodynamic forces or due to the ROV's own movement.

Thus, this umbilical (5) allows the device to be connected to the ROV of an RSV (ROV Support Vessel), or to be connected directly to the front of a stationary production unit that launches and operates the ROV from the platform (FSPU DL), and is operated remotely in both cases.

The pole (8) is also mounted on the main structure (1), which is the support where the camera and pan & tilt lighting (9) are mounted, which is the assembly responsible for enabling a third-person view of the operation.

Therefore, the manipulator device with diverless docking in a pipeline has three main functions:
docking at the work site, which can be a pipeline or another structure to which the at least two grippers (4), when closed, can be attached;
moving the at least two manipulators (3) as required by the operation; and
viewing, through the camera and pan & tilt lighting assembly (9), whether the operation is being correctly performed.

To perform the operations, the device can be controlled by means of an umbilical that connects the same to an ROV of an RSV or it can be remotely controlled by the platform, also by means of an umbilical.

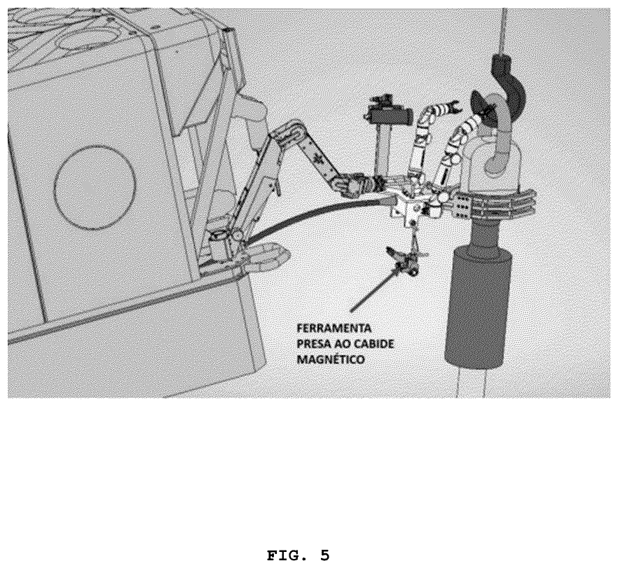

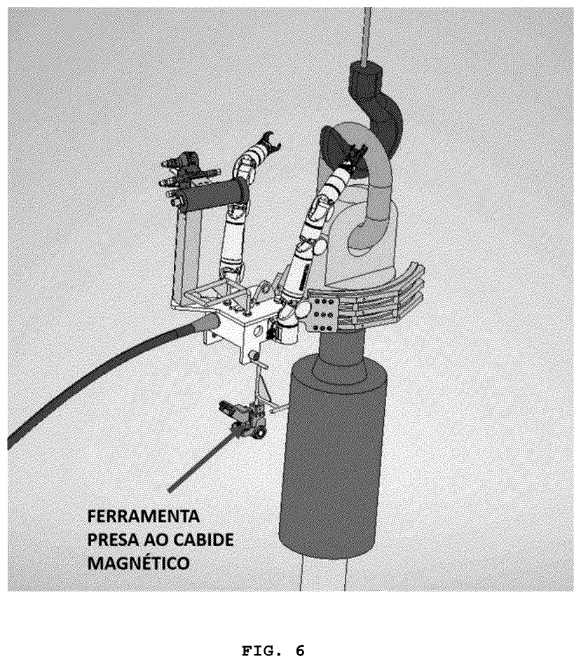

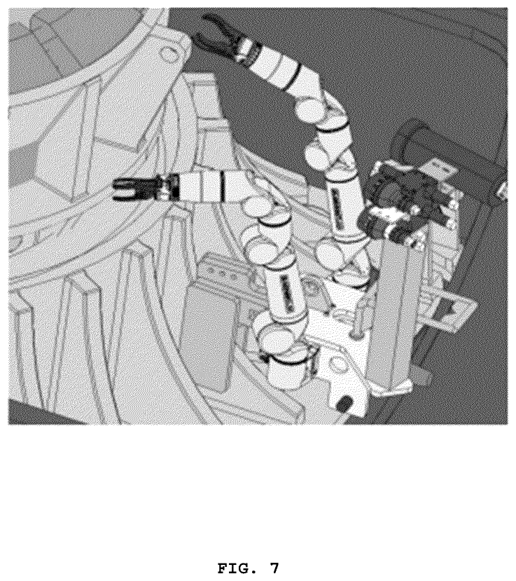

In this way, for both ways of controlling the manipulator device with diverless docking in a pipeline, the method for positioning and controlling the device consists of:
i) using an ROV, or a human diver, to dock the device at the work site, as shown in FIG. 5;
ii) closing the grippers on the surface of the work site, as shown in FIGS. 6 and 7.
iii) removing the ROV and leaving the device docked at the work site.

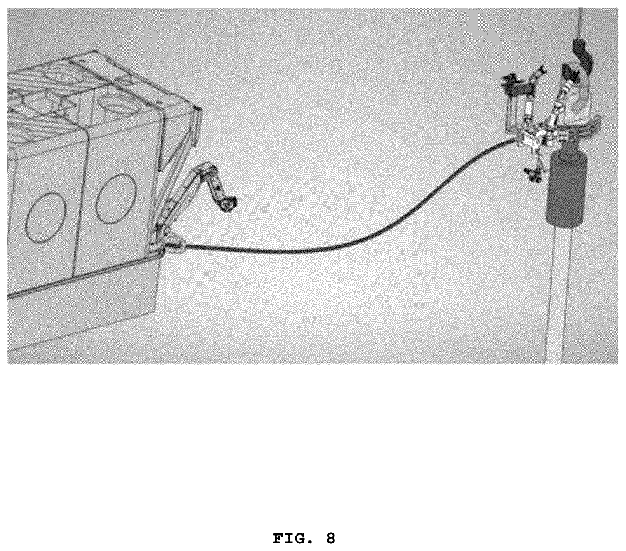

If the device is operated by an ROV from an RSV, after attaching the device at the work site, the ROV moves away and controls the same remotely by means of an umbilical, in order to decouple the movement of the ROV from the device and avoid the problems of maintaining position in the Tidal Variation Zone (TZ), as shown in FIG. 8.

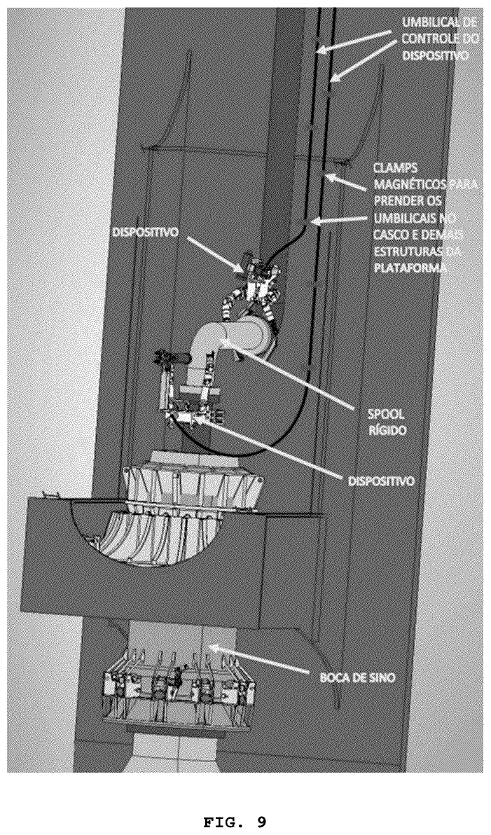

If the device is operated directly from a platform, after the ROV attaches the same, the umbilical can be clamped to the SPU winch cable or it can be organized by being secured to the hull and other structures of the platform by means of magnetic clamps, as shown in FIG. 9.

Therefore, the subsea maintenance and inspection operations do not necessarily depend on the ROV or the human diver, since what is indispensable is an arm with one hand, which can be a human arm that reaches the work site by swimming, or a robotic arm that reaches the work site by the navigation of a remotely operated vehicle (ROV), or a robotic arm is taken and attached to the work site by an ROV, or by a human diver, and will remain docked there until the end of the service.

The case in which the device of the present invention is taken and attached to the work site by a human diver is carried out when the device must be positioned in very confined places that the ROV does not have access to, and in the case in which the device is directly connected to the platform.

In this way, because it is attached, this device will not be subject to the difficulties of operating in the TVZ, as it will not need to maintain position by activating the thrusters to compensate for the resultant of the hydrodynamic forces, since it will already be secured and attached to the object in the work position, eliminating the problems that make certain operations in shallow water impossible with ROV, thus eliminating the relative movement between the platform and the device.

In addition, this device can also be used to optimize contracts for vessels with 2 ROVs, since a significant portion of the operations with 2 ROVs could be performed with 1 ROV and this device, enabling the reduction of the daily rate for these resources and, consequently, the reduction of the operating costs.

Finally, this device can optimize operations in FSPU DL (SPU front that launches and operates the ROV from the platform instead of an RSV vessel), if it is implemented in this type of resource and is launched directly from the SPU (stationary production unit—platform) instead of an RSV vessel (ROV Support Vessel), optimizing its FSPU DL operations, since the main causes of inefficiency are eliminated, such as meteoceanographic conditions, existing hydrodynamics between the platform and the conventional ROV and simultaneous operations, since, being attached to the platform, it would be attached as if it were one of the platform equipment.

Those skilled in the art will appreciate the knowledge presented herein and will be able to reproduce the invention in the presented embodiments and in other variants, encompassed by the scope of the attached claims.

1. A manipulator device with diverless docking in a pipeline, the manipulator device comprising:
a main structure, a handle, at least two manipulators, at least two grippers, an umbilical, a bend stiffener, a hydraulic actuator, at least one post, a camera and pan & tilt lighting assembly, and at least two magnetic hangers;
wherein the at least two grippers comprise a flat surface with a gear at its end;
wherein in the middle of the gears of the at least two grippers there is a hole;
wherein the at least two grippers further comprise at least two tips; and
wherein the hydraulic actuator comprises, at one of its ends, a rack in contact with the gears of the at least two grippers.

2. The manipulator device according to claim 1, wherein all structural components comprised in the device are mounted on the main structure, and wherein the main structure also comprises an eyelet.

3. The manipulator device according to claim 1, wherein the handle comprises a tab.

4. The manipulator device according to claim 1, wherein the handle is mounted on the rear part of the main structure.

5. The manipulator device according to claim 1, wherein the at least two manipulators are positioned on opposite sides of the main structure in a symmetrical manner.

6. The manipulator device according to claim 1, wherein the at least two tips can be shifted according to the geometry and dimensions of the structure in which the device will dock, and wherein the at least two tips are attached to the at least two grippers by means of screws.

7. The manipulator device according to claim 1, wherein the hydraulic actuator is positioned in the lower central part of the main structure.

8. The manipulator device according to claim 1, wherein the post mounted on the main structure is the support on which the camera and pan & tilt lighting are mounted.

9. The manipulator device according to claim 1, wherein the at least two magnetic hangers are positioned on opposite sides of the main structure in a symmetrical manner.

10. The manipulator device according to claim 5, wherein the at least two manipulators have at least two degrees of freedom in at least two articulations, and are attached to the sides of the main structure by means of screws.

11. The manipulator device according to claim 6, wherein the at least two tips can be made from a magnetic material.

12. A method for positioning the manipulator device with diverless docking in a pipeline, wherein the following steps are performed to position the device:
i) using an ROV, or a human diver, to dock the device at the work site;
ii) closing the grippers on the surface of the work site; and
iii) removing the ROV and leaving the device docked at the work site.

13. A method for controlling the manipulator device with diverless docking in a pipeline, wherein when the device is operated by an ROV of an RSV, after attaching the device to at the work place, the ROV, which remotely controls the manipulator device by means of an umbilical, is moved away.

14. A method for controlling the manipulator device with diverless docking in a pipeline, wherein when the device is operated directly from a platform, after the ROV attaches the same, the umbilical can be clamped to the SPU winch cable or can be organized to be secured to the hull and other structures of the platform by means of magnetic clamps.
